(19) United States
(12) Patent Application Publication
(10) Pub. No.: US 2026/0071090 A1
(43) Pub. Date: Mar. 12, 2026

(54) BROWN SEAWEED CONTAINING FORMULATIONS AND PROCESSES OF MAKING AND USING THE SAME

(71) Applicant: OCEANIUM LTD, Dunbeg Oban (GB)

(72) Inventors: Charlie BAVINGTON, Dunbeg Oban (GB); Ian VALLANCE, Dunbeg Oban (GB); Dana Elizabeth Sarah CLARKSON, Dunbeg Oban (GB)

(73) Assignee: OCEANIUM LTD, Dunbeg Oban (GB)

(21) Appl. No.: 19/110,784

(22) PCT Filed: Sep. 12, 2023
(86) PCT No.: PCT/GB2023/052362

§ 371 Date: Mar. 11, 2025

(30) Foreign Application Priority Data
Sep. 12, 2022 (GB) 2213321.9

(51) Int. Cl. C09D 101/02; C09D 105/04; C09D 189/00; D21H 11/12

(52) U.S. Cl. CPC C09D 101/02; C09D 105/04; C09D 189/00; D21H 11/12

(57) ABSTRACT

There is disclosed a residual processed seaweed product (kelp residue) provided by the processing of seaweed and uses of the residual processed seaweed product, for example to provide packaging products and other functional materials that similarly exploit the chemical composition of the residual processed seaweed product.

The present invention relates to a method to process seaweed, in particular brown or alginate containing seaweed, the residual processed seaweed product (kelp residue) provided by the processing and uses of the residual processed seaweed product, for example to provide packaging products and other functional materials that similarly exploit the chemical composition of the residual processed seaweed product.

### BACKGROUND

Seaweeds are known to contain commercially useful products such as alginates, bioactives, proteins and cellulose. Various methods of processing seaweeds have been determined to extract commercially useful products from the raw seaweed and provide a residual processed seaweed product. Such conventional extraction processing techniques allow a high yield of such commercially useful products such as alginate to be obtained from seaweed. Suitably such extraction processes to obtain alginate from seaweed may include bleaching of a seaweed portion using an alkaline bleaching composition and then extracting the alginate from the bleached seaweed portion. The bleaching composition may comprise standard bleaching techniques, for example the use of an oxidation catalyst and/or peroxide activator. Alternatively or additionally the process may comprise an acid composition treatment step and/or a depolymerisation step. The residual processed seaweed product following conventional extraction processing techniques is typically not considered to be of high commercial value.

Typically, after such extraction processes an alginate fraction comprising greater than 90% of soluble alginates is extracted from seaweed. As will be appreciated, in conventional extraction techniques, where processes to remove commercially useful products, such as alginates, have been determined, the aim is to remove as much of the commercially useful product as possible from the seaweed using the process. The processed seaweed residue is then considered as a waste product. Seaweed extracts have been used to create film forming materials for use in packaging, for example, as described in US2013/032336A.

Alginates extracted from seaweeds using conventional extraction techniques are known to be useful in many industries such as the food and drink industry, the pharmaceutical and medical industry, and the paper and textile industry.

Paper products, without additional processing steps or construction techniques, typically have poor barrier properties and are not therefore useful to store or package products. In particular it can be challenging to use paper to package many food products. Typically, to allow paper based packing to be used, paper is first altered by processing, for example, processing of the paper may be undertaken to provide a multi-layer packaging material. However, whilst such multilayer packaging material can enhance the functional properties of paper based products or packaging, these are typically difficult to recycle and thus are not considered to be environmentally advantageous. Whilst biodegradable packaging is available, the functional characteristics required to ensure, for example food freshness, are challenging and it would be advantageous if alternative sustainable packing material could be provided. It would be advantageous if improvements in the barrier functions of paper products could be achieved.

### SUMMARY OF INVENTION

The inventors have determined a method of processing seaweed which provides a residual processed seaweed product which is useful in further processes such as to provide; packaging material, leather like material, textile material, or for use in printing and the like, whilst also providing other commercially desirable products. The residual processed seaweed/kelp residue is composed of two main fractions an alginate fraction and a non-alginate fraction. The alginate fraction can be water soluble or water insoluble and the non-alginate fraction is typically water insoluble.

Suitably the residual processed seaweed product/kelp residue is derived from alginate containing algae in a biorefinery process. Suitably the alginate containing algae may be brown algae. The residual processed seaweed product/kelp residue typically consists an alginate component, together with cellulose, proteins, pigments and water insoluble inorganic salts. The water soluble fraction of the residual processed seaweed product/kelp residue is typically most commonly a water soluble salt of alginic acid and the insoluble fraction is a mixture of cellulose, proteins, pigments and insoluble inorganic salts. The residual processed seaweed product/kelp residue can also be fully water insoluble if it is produced with the alginate fraction as alginic acid or a water insoluble salt of alginic acid. The alginate fraction can be in the range 10 to 90% w/w more typically 10 to 80% w/w of the residual processed seaweed product/kelp residue. The alginate fraction is usually a water soluble salt of alginic acid.

Suitably the residual processed seaweed product of the present invention may be utilised in processes to form packaging material, leather-like material, and textile fibre or material. Suitably such processes provide packaging material, leather-like material or textile material with desirable functional properties. For example, there is a need for packaging material which may be fully compostable, in particular, it would be advantageous if the packaging material could be used in food applications. Suitably the packaging material may be disposed of with food waste. Suitably the packaging may not add non-biodegradable materials to a marine environment. Suitably the packaging may be home compostable. Suitably the packaging may be appropriate for use with food and nutrition products.

Accordingly, there is provided a process to provide a residual processed seaweed product wherein the process comprises the steps:
providing an alginate containing seaweed portion,
water washing the alginate containing seaweed portion,
acid washing the washed alginate containing seaweed portion,
separating the acid washed alginate containing seaweed portion from the acid wash,
providing the acid washed alginate seaweed portion to a neutralising step to provide a residual processed seaweed product fraction wherein the product fraction comprises a fraction of between 1-90% soluble Alginate and 1-99% of insoluble materials.

Suitably the alginate containing seaweed portion is a brown seaweed.

According to a second aspect of the invention there is provided the processed residual seaweed of the first aspect of the invention. Suitably the processed residual seaweed comprises insoluble materials selected from Cellulose, Proteins and insoluble alginate

Suitably the brown/alginate seaweed portion may be pre-treated, prior to the water washing step, by abrading, cutting, shredding or milling. Suitably the seaweed portion may have a largest cross section of about 5 mm, suitably 2.5 mm, suitably 2 mm. Suitably the seaweed portion may have a thickness in the range of about 200 μm to 4 mm, suitably about 1 mm to 4 mm, more suitably 2 mm to 4 mm.

Suitably the water washing step may use water from any suitable source, for example fresh water or potable water.

Suitably the seaweed portion is derived from alginate-containing seaweed, suitably brown alginate containing seaweeds, for example algenophytes. Suitably the algenophytes may be selected from the orders Laminariales, Fucales or Ectocarpales, Macrocystis, for example M. pyrifera, Lessonia, and Sargassum. Suitably the brown seaweed is selected from at least one of:
Laminaria abyssalis,
Laminaria agardhii,
Laminaria appressirhiza,
Laminaria brasiliensis,
Laminaria brongardiana,
Laminaria bulbosa,
Laminaria bullata,
Laminaria complanata,
Laminaria digitate,
Laminaria ephemera,
Laminaria farlowii,
Laminaria groenlandica,
Laminaria hyperborean,
Laminaria inclinatorhiza,
Laminaria longipes,
Laminaria multiplicata,
Laminaria nigripes,
Laminaria ochroleuca,
Laminaria pallida,
Laminaria platymeris,
Laminaria rodriguezii,
Laminaria ruprechtii,
Laminaria sachalinensis,
Laminaria setchellii,
Laminaria sinclairii,
Laminaria solidungula, and
Laminaria yezoensis

Suitably the brown seaweed may be from the order Fucales, suitably of the genus Ascophyllum. Suitably the seaweed may be selected from S. latissima, L. digitata, A. escuelnte, L. japonica, U. pinnatifida, Sargassum sp. A. nodosum, or Fucus sp.

Suitably all processing steps may take place at room temperature (about 20 degrees C.) or at targeted elevated temperatures. Processing times for the acid and water washes are optimised to maximise extraction of target soluble value streams. A wide range of materials could be used to neutralise the acid cake. The primary purpose of the neutralisation is to create a water soluble alginate salt from the water insoluble alginic acid that is present in the acid washed cake.

The positive ion associated with the base, ion exchanges with the hydrogen present in the alginic acid. Suitably any base may be used e.g. sodium, potassium or ammonium carbonates or hydroxides could be used. Suitably to provide a water soluble alginate, a positive ion associated with the base may be monovalent (+1 positive charge). Suitably sodium, potassium or ammonium etc. are suitable. Usually milder bases such as carbonate are used to avoid using strong bases like hydroxide, as strong bases are more likely to damage the molecules in the wet cake.

Suitably, bases with divalent or multivalent positive ions may be used for the neutralisation. e.g Calcium or Magnesium carbonate. These would neutralise the alginic acid (ion exchange with the portion of the alginic acid) to insoluble alginate salts. Suitably the acid and water washes aim to minimise the removal of alginate molecules present in the seaweed. Suitably the processing can aim to maximise the alginate content of the seaweed/kelp residue.

Optionally following neutralisation, the alginate content of the seaweed residue can be reduced in a further processing step to separate the soluble alginate from the other insoluble components of the post water and acid washed seaweed residue.

Suitably the seaweed residue comprises an alginate fraction of about 1% to 90% w/w, more suitably 1-80% dry soluble alginates. Suitably soluble alginates may be selected from Na Alg (Sodium Alginate) (Soluble), KAlg (Potassium Alginate) (Soluble), and/or NH4Alg (Ammonium Alginate) (Soluble). Suitably the alginate fraction may also comprise insoluble alginate for example metal alginates Ca{Alg}2, (Fe(Alg)3, Al(Alg)3) and/or other organic alginates such as propylene glycol alginate PGAlg (Propylene Glycol Alginate) (Soluble).

Suitably the processed residual seaweed comprises alginate fractions which can be soluble or insoluble and the other insoluble fraction of the seaweed residue is made up of materials such as cellulose, protein, pigments, and/or inorganic minerals. Suitably, the alginate present in the residual seaweed extract/kelp residue after neutralisation is mostly soluble. However some insoluble alginate salts present in the starting seaweed may not be converted into alginic acid and so into soluble salts.

Typically the alginate present in the seaweed at the start of processing is mostly in the form of the insoluble calcium salt form. The acid wash step can convert this calcium alginate Ca(Alg)2 to alginic acid (HAlg) by ion exchange. The neutralisation step converts the HAlg to a target salt usually a soluble one.

Suitably the processed residual seaweed may be dried. If alginate is not removed during processing of the seaweed, the resulting processed residual seaweed/kelp residue is high in alginate (up to 90% of the dry weight) If alginate is removed during the processing, the resulting processed residual seaweed/kelp residue will contain much less alginate, typically <15% w/w and as little as 1% w/w alginate. Processed residual seaweed alginate level defines for which applications the kelp residue is most suited.

Suitably the neutralised wet cake comprising the processed residual seaweed fraction (kelp residue) may be further processed to use the processed residual seaweed fraction in particular functional applications. The end use of the processed residual seaweed fraction/kelp residue can be tailored depending on the percentage of alginate in the residual seaweed versus its other insoluble component level.

For example, the inventors have found that a high ratio of water soluble alginate fraction in the residual processed seaweed fraction is useful in mix formulations for film-forming compositions, as well as in composites with other plastics, preferably, but not limited to biodegradable plastics such as Poly Lactic Acid, PLA, PolyHydroxy Alkonate PHA, Polybutylene Adipate Terephthalate PBAT whereas a low ratio of water soluble alginate fraction in the processed seaweed fraction is useful for composite formulations with other plastics and in paper and board formulations, preferably, but not limited to biodegradable plastics such as Poly Lactic Acid, PLA, PolyHydroxy Alkonate PHA, Polybutylene Adipate Terephthalate PBAT as well as in paper and board formulations as a component in the pulp used to form paper and board webs. Suitably the processed residual seaweed fraction can be further processed to provide specific residue sized portions, for example residue powder with particle size (ps) average 60 μm, residue fibre with particle size of 100 μm to 600 μm, or residue flake with particle size 3 mm to 5 mm. Suitably, the method can include a step of sizing of the particles within the processed residual seaweed. It is considered that processing to smaller particle size averages e.g. <20 μm or even sub micron value may improve performance in some applications listed below.

The seaweed residue can be mixed with other components in formulations that also comprise various levels of water content. The inventors have found it useful to define
High water content mixes where water content ≥70% w/w water,
Medium water content mixes with 25-50% w/w water mixes, and
Low water content mixes with <10% w/w water suitably <0.5, <0.25, in particular <0.1% w/w.

Very low water content kelp fiber is advantageous in the processing of thermoplastic composites.

Particular mixes may be advantageously used in composite applications as well as defining how the mixes are made and further processed.

According to a third aspect of the present invention, there is provided a high water content formulation comprising the processed residual seaweed fraction as discussed herein and wherein 70% w/w or greater of formulation is comprised of a water.

Suitably a high water content formulation is prepared using wet mixing methods and is suitable for further processing as coatings and/or inks. The processed seaweed residue component utilised in high water content mixes preferably contains high levels of soluble alginate which act as a film forming agent.

High water content, composites, typically >70% w/w water can be utilised as inks or coatings and used to provide functional and/or decorative layer on substrates such as paper, card, cardboard, textiles or films. Alternatively the high water content mixes can be coated or printed in one or more passes, onto reusable carrier plastic films from which a functional compostable film can be removed following drying and if required curing. Along with kelp residue these formulations can contain plasticisers, additional film forming polymers, fillers and selection of functional additives. Suitably a plasticiser may be selected from glycerol, sorbitol, mannitol, polyethelengyols (PEG), oils for example, mineral oil, vegetable oil, fatty acids, natural and synthetic waxes.

Suitably there is provided a paper or cardboard composite comprising:
(i) 1-60% w/w residual seaweed product comprising cellulose, proteins and soluble or insoluble alginates, wherein the residual seaweed product comprises 0-80% w/w alginate;
(ii) 40-99% w/w lignocellulosic fibrous material;
(iii) 0-30% paper and board product typical functional additives.

Suitably, additional film forming agents may be selected from a range of natural and/or water soluble, preferably biodegradable polymers. These could include but are not limited to modified cellulose derivatives e.g. Carboxy Methyl Cellulose, Methyl Cellulose, Hydroxyl Ethyl Cellulose, Hydroxpropyl Celluloses, Natural and modified starches, plant and animal proteins, for example gluten, gelatines, Zein, potato proteins etc. Polyvinyl Alcohols, and Polyvinvyl Alcohol Polyvinyl Amine co-polymers. Suitable fillers can be selected from koalin, bentonites, silicas, TiO2, chalk and these materials can also function as colour modifiers, specifically lighteners and odour control agent. Suitable functional additives and property modifiers can be hydrophobing agents including lipids, resin(s), wax(es), oil(s), shellac or shellac analogues. Suitably, waxes and oils may be selected from paraffin wax, calendula, bees wax, candelilla wax, polyethylene wax, fatty acids. Reactive hydrophobing agent such as Alkyl Ketene Dimers and Alkyl Succinic Anhydrides or Tall Oil Rosins and their functionalised derivatives may also be used. Additionally or alternatively nanocellulose fibres from seaweed and wood sources may be provided.

Suitably, a high water content composite formulation based non volatile content can be
kelp residue wherein the kelp residue is provided in the range 1-80% w/w, suitably 10-60%, more typically 40-60% w/w;
Plasticiser 0-60%, suitably 0.5-60%, suitably 10-60%, more typically 10-40%,
additional film forming polymer, suitably 10-80%,
filler, suitably 0-30%,
and functional additives 0-30%.

For example kelp residue 11.5% w/w, Hydroxyl Ethyl Cellulose (90K Mw Supplier Merck) 1.0% w/w, Poly Vinyl Alcohol (ST90002DHV Supplier Scitech) 1.0% w/w, Glycerol 6.5% w/w, water 80% w/w

Suitably substrate bases for coating the high water composite materials onto might be paper, paper board or cardboard, or Polyethylene Terephthalate (PET) films or other plastic carrier films.

A high water composition comprising seaweed residue with 1-75% alginate fraction and 0-99% residual processed seaweed product fraction wherein the product fraction comprises substantially soluble alginate and other insoluble component(s) was used to form a coating composition or an ink to be applied to a substrate. The coating composition is typically suitable to provide a decorative or oxygen and oil barrier coating to a substrate, for example paper or textiles on which it is applied.

According to a fourth aspect of the invention there is provided a medium water content formulation comprising the processed residual seaweed fraction as discussed herein and wherein between 25 and 50% w/w the formulation comprises water. These formulations can be prepared and further processed using thermoplastic mixing equipment and can be processed into pellets as well as 2D films and 3D parts e.g. injection moulded parts. Suitably on further drying, such medium water formulations can be used as functional items e.g. packaging films or containers. Seaweed residue component utilised in medium water content formulations preferably contains high levels of soluble alginate which act as a film forming agent.

Accordingly, a further aspect of the invention provides an extruded film comprising the processed residual seaweed of the invention. This could include coextruded films where the film comprising the residual seaweed of the invention is one layer in a multilayer film.

Suitably injection moulded parts comprising the processed residual seaweed of the invention may be provided. Suitably compression moulded parts comprising the processed residual seaweed of the invention may be provided. Suitably blow moulded parts comprising the processed residual seaweed of the invention may be provided. Suitably parts produced by other plastic processing technologies e.g. blown film, extruded profile may be provided. Suitably coatings and inks comprising the processed residual seaweed of the invention can be provided. Suitably coatings and inks comprising the processed residual seaweed of the invention can be provided.

Suitably high or medium water-soluble formulations may be provided with further components, for example additional film/matrix forming polymers, plasticisers, elastomers and functional additives. In all cases such additional components may comprise biodegradable polymers.

Based on their dry content, both the high and medium water content formulations may contain the listed components in the following percentages

Processed Seaweed Residue (Kelp Residue) 1-80% w/w, more typically 40-60% w/w, plasticiser 0.5-50%, more typically 10-40%, 0-50% more typically 10-40% additional film forming polymer, Functional additives 0-30%.

Suitably a formulation coating or ink composite, comprises non volatile components wherein the non volatile components of the said composite comprises:
10-60% w/w residual seaweed product as discussed herein, wherein the residual seaweed product comprises an alginate fraction comprising 1-80% w/w water soluble alginate;
combined with functional additives, selected from
(a) 10-60% w/w plasticiser;
(b) 10-60% w/w film forming polymer;
(c) 0-30%, suitably 0-20% % w/w filler.
(d) 0-30%, suitably 0-20% w/w other functional materials e.g. hydrophobising agents crosslinkers, colour pigments

Suitably a coating or ink composite may be provided, wherein the non volatile components of the said composite comprise 5-30% w/w residual seaweed product as discussed herein with the balance volatile fraction 95-70% w/w being water

Suitably, a Film/Matrix forming agent may be provided to the processed residual seaweed of the invention, for example synthetic polymers, natural polymers such as starches and modified starches, modified celluloses (Hydroxy Alkyl Celluloses (e.g. Ethyl Propyl), carboxy Alkyl Celluloses (Methyl Ethyl etc), proteins, e.g. Pea, Wheat Gluten, Casein, Animal gelatines, Zein, Carrgeenan, pectins, or PVOH, (Polyvinyl Alcohols). Suitably, dispersions of natural and/or synthetic non water soluble polymers like Polyvinyl acetate or Polyvinyl Butyrate may be used. Suitably natural or synthetic polymers selected from polyvinylpyrrolidone, acrylates, acrylamides and copolymers may be used. Suitably polyols such as Gly, ethylene glycol, diethylene glycol, triethylene glycol, tetraethylene glycol, polyethylene glycol, propylene glycol, sorbitol, mannitol and xylitol, fatty acids, monosaccharides (glucose, fructose and sucrose), ethanolamine, urea, triethanolamine, vegetable oils, lecithin, waxes, amino acids, surfactants may be used.

Suitably, a plasticising agent that may be provided to the processed residual seaweed of the invention may be selected from glycols, sorbitol, mannitol, polyethylene glycols (PEG), oils, glycerol triacetate mineral oil or vegetable oil, fatty acids, waxes Tall Oil Rosin and its derivative or the like.

Suitably an elastomer may be selected from Natural Latex, Thermoplastic Polyurethanes, Triheptanoin (and) Coco-Caprylate/Caprate (and) Polyurethane-100 and similar

Suitably, a hydrophobing agent that may be provided to the processed residual seaweed of the invention may be selected from a lipid, resin(s), wax (ex), oil(s), shellac or shellac analogues. Suitably, waxes and oils may be selected from Alkyl ketene dimers, Alkenyl Succinic Anhydride, Tall Oil Rosin and its derivatives, paraffin wax, calendula, bees wax, candelilla wax, polyethylene wax, fatty acids.

Suitably pigments and dyes that may be provided to the processed residual seaweed of the invention may be selected from natural and synthetic dyes as well as colorant pigments and dyes typically used in screen printing and other commercial ink formulation. These can include inks e.g. TiO2, C-phycocyanin Spirolina blue dye, carbon black, Turmeric. Selected Dyes and pigments are added at controlled levels alone or in combination in addition to the natural pigments present in the processed seaweed residue to achieve targeted non standard colours.

Suitably, a filler may be selected from Silica, Bentonite, Kaolin, clays, TiO2, Colour pigments, carbon Black, and/or Carbon Nanotubes.

Suitably the ink and coating formulations, for example high water content formulations, may be applied to a surface of a base material.

Suitably, a coating process may include an emersion coating, spray coating, screen printing and/or other printing or coating methods as would be known in the art e.g. blade or slot die.

Suitably, the thickness of a dry coating thickness would be between 1 μm and about 5000 μm. More typical 30 μm to 500 μm. The final dry coating thickness may be related to the maximum wet coating weight, the chosen coating technique can achieve—the maximum wet coating thickness that can be reasonably dried and how many coating passes are applied. For example, for screen printing with a high moisture mix with 80% water content, the maximum wet thickness is about 100 microns, (dry about 20 microns) and a practical maximum number of screen print passes would be 5-7. If the same mix is applied with a blade coater, the maximum wet thickness might be 2000 microns per coating pass (400 microns dry) assuming that this could be economically dried. At that wet thickness more than one coating pass would be unlikely unless the application was very high value.

Suitably a base material might be paper, paper board or cardboard or textiles, plastic films, or synthetic films or combinations thereof. Suitably a substrate when applied to a base forms packaging comprising a material combination of residue containing mix and paper fibres. Suitably the compositions of the invention may be applied to a base material wherein, for example, the base material is comprised of paper fibres, for example, a base to which the composition of the invention may be applied may comprise a lignocellulosic material prepared by a chemical or mechanical separation of cellulose fibre from wood, crops, or paper/paper pulp.

According to a further aspect of the invention, there is provided a process of preparing packaging materials comprising the processed residual seaweed of the invention.

Suitably a medium water content formulations can be processed in thermoplastic extrusion equipment to make pellets and or to make 2D films or 3D injection moulded parts.

A medium water content composition/formulation/composite typically comprises 10-70% w/w water. These compositions are pseudo-thermoplastics and are processable using thermoplastic processing equipment. They can be used to make 2D (Films) and 3D products using specific equipment. End products are typically prepared in secondary processes using fully compounded pellets of the composite prepared in a suitable compounding twin screw extruder.

Along with kelp residue these formulations can contain plasticisers, additional film forming polymers, fillers and selection of functional additives. Suitably a plasticiser may be selected from glycerol, sorbitol, mannitol, polyethylene glycols (PEG), oils for example, mineral oil, vegetable oil, fatty acids, natural and synthetic waxes.

Suitable, additional film forming agents to modify properties such as the tensile strength or elasticity or barrier properties may be selected from a range of natural and/or water soluble, preferably biodegradable polymers. These could include but are not limited to modified cellulose derivatives e.g. Carboxy Methyl Cellulose, Methyl Cellulose, Hydroxyl Ethyl Cellulose, Hydroxpropyl Celluloses, natural and modified starches, plant and animal proteins, e,g, gluten, gelatines, Zein, potato proteins etc. Polyvinyl Alcohols, Polyvinyl Alcohol Polyvinyl Amine co-polymers.

Suitable fillers can be selected from koalin, bentonites, silicas, TiO2, chalk and these materials can also function as colour modifiers, specifically lighteners and odour control agent.

Suitable functional additives and property modifiers can be hydrophobing agents lipids, resin(s), wax (ex), oil(s), shellac or shellac analogues. Suitably, waxes and oils may be selected from paraffin wax, calendula, bees wax, candelilla wax, polyethylene wax, fatty acids. Reactive hydrophobing agent such as Alkyl Ketene Dimers and Alkyl Succinic Anhydrides, Tall Oil Rosins and their functionalised derivatives may also be utilised. Additionally or alternatively, nanocellulose fibres from seaweed and wood sources may be used.

A suitable medium water content composite formulations based non volatile content can be Kelp Residue 1-80% w/w, more typically 40-60% w/w, plasticiser 0.5-50%, more typically 10-40%, 0-50% more typically 10-40% additional film forming polymer, and functional additives 0-30%. For example, a medium water composite formulation may comprise kelp residue 32.18% w/w, Sorbitol 16.09% w/w, C16:C18 1:1 ration Alkyl Ketene Diner 0.74% w/w, nanocellulose 0.49% w/w, kaolin 0.49% w/w, water 50% w/w.

Accordingly, a further aspect of the invention provides a thermoplastic material or thermoplastic composition comprising the processed residual seaweed of the invention combined with a second plastic component, preferably, but not limited to, biodegradable plastics, in order to make a plastic composite. These are typically considered to be low water composites.

Suitably a pseudothermoplastic composite is provided where the non volatile components comprise:
10-90% w/w residual seaweed product as discussed herein, wherein the residual seaweed product comprises 50-80% w/w alginate; and combined with functional additives, selected from
(a) 10-60% w/w plasticiser;
(b) 10-80% suitably 10-60% w/w film forming polymer;
(c) 0-30%, suitably 0 to 20% w/w filler.
(d) 0-3%, suitably 0-20% w/w other functional materials e.g. hydrophobising agents crosslinkers, colour pigments, optionally wherein
the non volatile fraction of the coating composite can be 50-70% w/w with the balance volatile fraction 50-30% w/w being water.

Suitably, the pseudothermoplastic composition comprises a plasticiser selected from one or more of glycerol, and sorbitol.

Suitably a pseudothermoplastic composition is provided, wherein the alginate comprises one or more of sodium alginate, calcium alginate, potassium alginate, other ionic salt of alginate or alginic acid

Suitably a thermoplastic composition is provided comprising:
(i) 1-90% residual seaweed product as discussed herein, wherein the residual seaweed product comprises, comprises 10-80% w/w alginate;
(ii) 10-99% w/w polymer;
(iii) 0-50% w/w functional additives, and further comprising 0-10% w/w water.

In such low water compositions, the polymer is providing the thermoplastic functionality. Suitably, the thermoplastic composition comprises a plasticiser matched to the main polymer content. Suitably a thermoplastic composition is provided, wherein the alginate comprises one or more of sodium alginate, calcium alginate, potassium alginate, other ionic salt of alginate or alginic acid.

In suitable low water composites, a thermoplastic material may be a plastic composite, for example comprising the processed residual seaweed of the invention together with suitable plastics preferably biodegradable plastics such as PolyLactic Acid (PLA), PolyHydroxy Alkonates (PHA's), Poly Butylene Adipate Terephthalate (PBAT), Poly Butylene Succinates (PBS) or CaProlactone (CPL). The preferred form of low water formulations use biodegradable plastics. However, traditional synthetic polymers could also be used plastics e.g. Polyethylene, (PE); Polypropylene, (PP); Polyvinyl Acetate (PVA) EthylVinyl Acetate etc. Low water composites can also contain typical functional plastic additives e.g. plasticisers, and fillers etc. Suitable fillers can be selected from koalin, bentonites, silicas, TiO2, chalk and these materials can also function as colour modifiers, specifically lighteners and odour control agent. Low water composites may be processed in thermoplastic extrusion processing equipment to make pellets, which can subsequently be further processed in thermoplastic processing equipment to make functional parts e.g. injection moulders.

A low water content composition, typically comprises <10% w/w water, preferably <1%, suitably <0.1% w/w. It can be processed using thermoplastic processing equipment to make 2D and 3D products using specific suitable equipment. End products are typically prepared in secondary processes using fully compounded pellets of the composite prepared in a suitable compounding twin screw extruder. The alginate fraction in the kelp residue used in these composites can be either soluble or insoluble.

Along with the kelp residue which acts as a natural filler fraction or in the case of biodegradable polymers a composting accelerator, these formulations typically include synthetic thermoplastics including, but not limited to, PE Polyethylenes PP polypropylene, and preferably biodegradable thermoplastics, including but not limited to PLA (Poly Lactic Acids), PHA Poly Hydroxy Alkonates, PBAT PolyButylene Adipate

Terephthalates, Natural PBST Poly Butylene Adipate Succinates, PCL Polycaprolactones, Polyester Amides, along with other typical functional additives used in thermoplastics e.g. plasticisers, colour pigments and inorganic fillers. The composite make up can be kelp residue 1-80% w/w, thermoplastic polymer 20-99% w/w, plasticiser, plasticiser 0-30% w/w, filler 0-30% w/w. Suitable plasticisers can be soya bean oil, lactic acid esters, Polyethylene Glycols and PLA Oligomers and Low Melting point Caprolactones. This use of the residual seaweed product is a separate aspect of the invention. Other functional additives known in the art could also be included at appropriate levels. Processing of Low water Content Composite typically is undertaken using pelletisation. The kelp residue is compounded into a plasticiser at 2:1 plasticiser: Kelp Residue ratio. The resulting batch is then further compounded to a commercial grade PLA to produce fully Compounded pellets. The pellets can be subsequently used in a commercial Injection mould to produce injection moulded part. Analysis of Injection moulded materials can provide materials with a Flex Strength 13—22 MPa; Tensile Strength 12-29 MPa, Elongation at Break 2%.

Suitably there is provided a thermoplastic composition comprising residual seaweed product and PLA, wherein the presence of residual seaweed product provides for an increased degradation rate when compared to a control composition comprising PLA without the residual seaweed product. In embodiments the residual seaweed product is at least 8% by weight of the composition. In embodiments the residual seaweed product is at least 10% by weight of the composition and the increase in biodegradation rate compared to the PLA control is an increase of about 100%.

Suitably formulations as described herein may comprise functional additives and/or property modifiers. Such functional additives and/or property modifiers can comprise hydrophobing agents lipids, resin(s), wax (ex), oil(s), shellac or shellac analogues. Suitably, waxes and oils may be selected from paraffin wax, calendula, bees wax, candelilla wax, polyethylene wax, fatty acids. Reactive hydrophobing agent such a Alkyl Ketene Dimers and Alkyl Succinic Anhydrides, or other hydrophobing agents for example Tall Oil Rosins and their functionalised derivatives, Nanocelluose fibres from seaweed and wood sources could also be used.

Suitably the process may further comprise an alginate extraction step. Suitably the alginate extraction step may create a dealginated processed residual seaweed with less than 20% w/w dry alginate. Suitably such dealginated processed residual seaweed (kelp residue) may be used as discussed above, for example applied to a substrate such as paper or board or used in forming films or composites. Suitably in such further processing methods a particular size of processed residual seaweed may be selected for use in the process, for example with a particle size in the range 3 to 5 mm. Suitably such a dealginated processed residual seaweed may be used as an organic filler at up to 30% w/w of the formed paper/board web without significantly disrupting web formation or the performance properties of the resulting finished product.

Accordingly a further aspect of the invention provides a low water content composite material comprising the processed residual seaweed fraction as discussed herein and wherein between 0 and 10% w/w the formulation comprises water.

Suitably the residual processed seaweed product can be prepared in any of its High, Medium or Low composite material forms so as to provide materials with a leather like appearance and feel.

Suitably such a medium or low water composite material can be processed using thermoplastic processing equipment and be extruded, injection moulded or pressed to form 2D or 3D a material with a desired thickness.

Alternatively the low or medium water content composites can be extruded directly onto to a carrier substrate e.g. paper, board or textile or other plastic film which act as a backing and/or barrier layer, or fully formed extruded films can be laminated to such backing materials.

Alternatively the low and medium water composites could also make up one layer in a multiple layer co-extruded film where the materials making up the individual layers are simultaneously extruded through a suitable multiple head coating die, where the residual processed seaweed product provides the leather-look and feel and each of the coextruded layers provide a targeted functionality e.g. backing, barrier.

Suitably such a high water content can be coated or printed onto a suitable re-usable release surface in one or more coating or printing pass, then dried, removed from the carrier to produce a film of controlled thickness.

Alternatively such a high water content composite can be printed or coated in one or more printing or coating pass, directly onto and bonded to a carrier substrate e.g. paper, board or textile or other plastic film which act as a backing and/or barrier layer, or fully formed dried films can be laminated to such backing materials.

The residual processed seaweed product prepared to provide a leather like material or textile backed or laminated product may form a separate aspect of the invention. Suitably the residual processed seaweed product can be mixed in an ionic liquid then subjected to a spinning process. Suitably the residual processed seaweed product may be mixed with cellulose prior to the spinning process. Suitably, the residual processed seaweed product may be mixed with cotton prior to the spinning process Suitably the spinning provides fibres which may be incorporated with clothing or other textile material.

Embodiments of the invention will now be described by way of example only with reference to the accompanying figures in which:

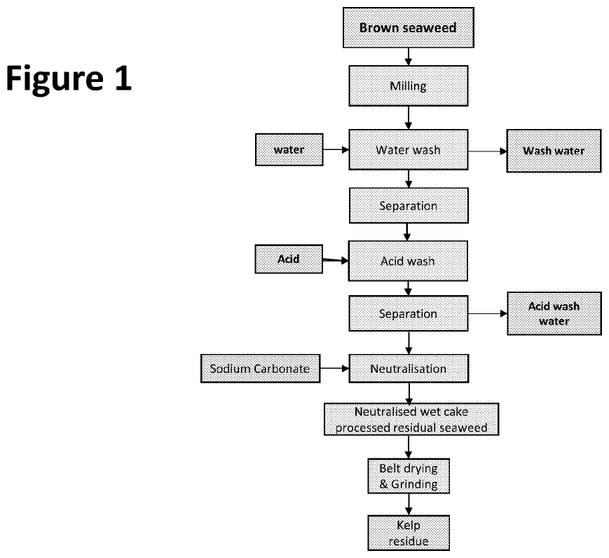

FIG. 1 illustrates the process of forming the kelp residue/processed residual seaweed;

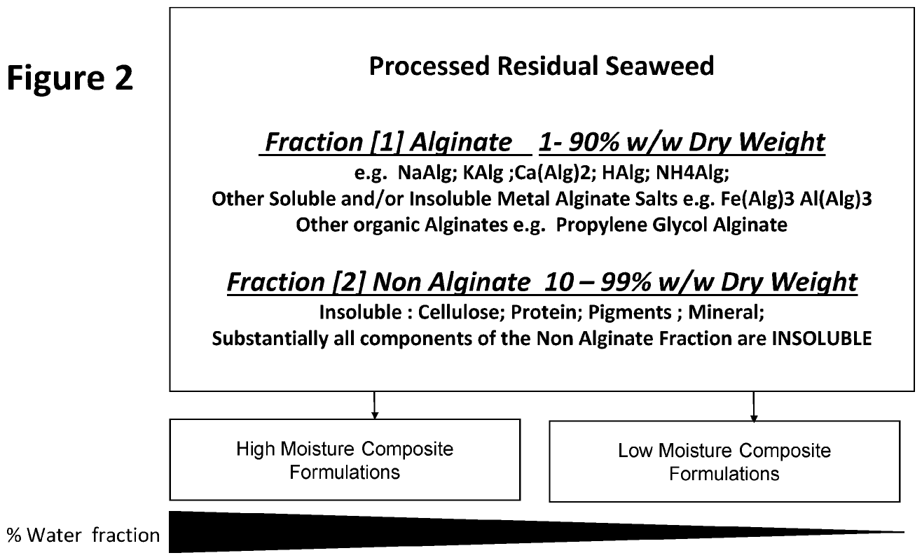

FIG. 2 illustrates the components in the kelp residue/processed residual seaweed and the composite formulations depending on % water fraction;

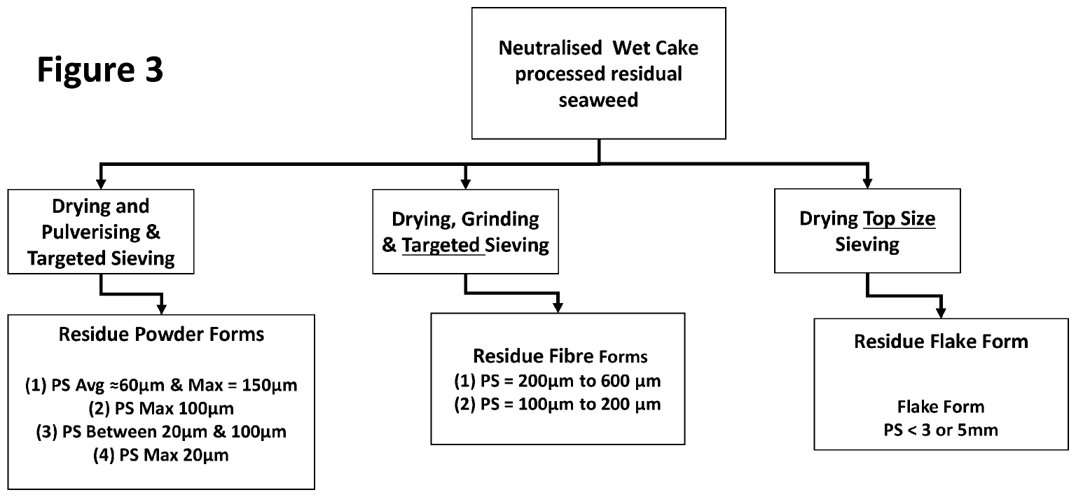

FIG. 3 illustrates various particle sizes of kelp residue/processed residual seaweed that can be prepared;

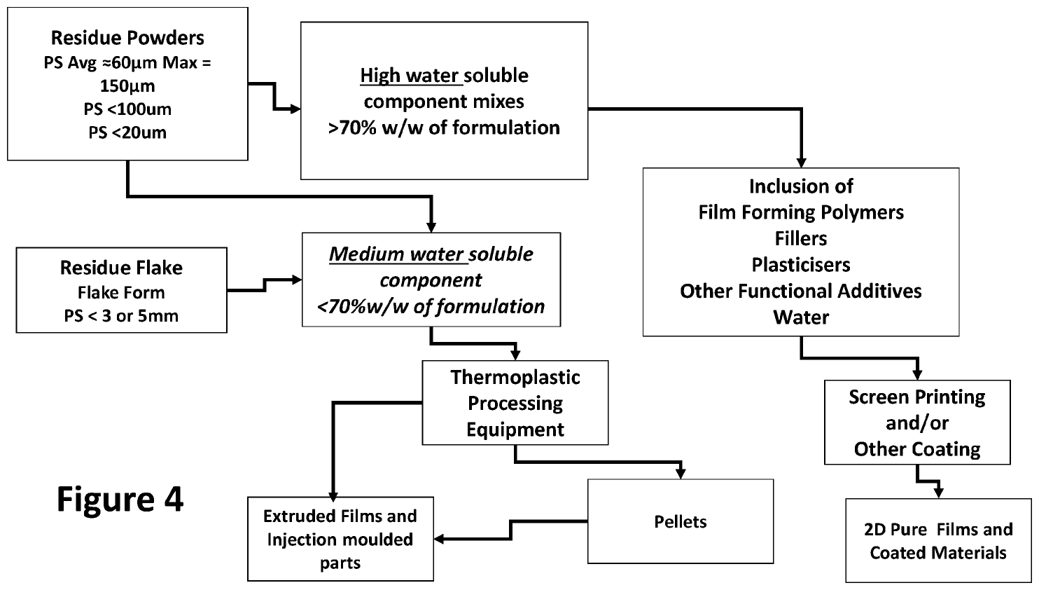

FIG. 4 illustrates example processing downstream process to form kelp residue/processed residual seaweed for High and Medium Water content formulations;

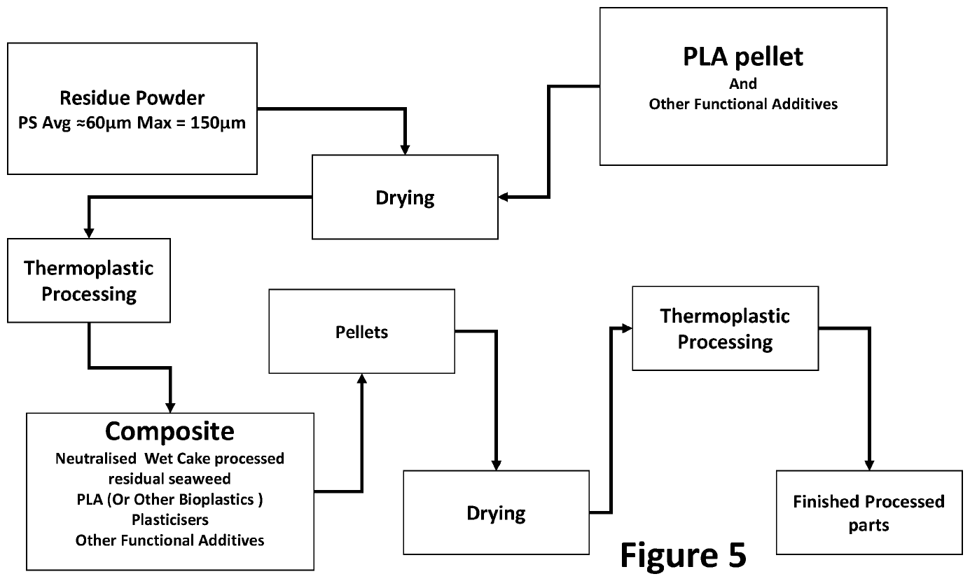

FIG. 5 illustrates example processing downstream process to form kelp residue/processed residual seaweed for Low water composite formulations;

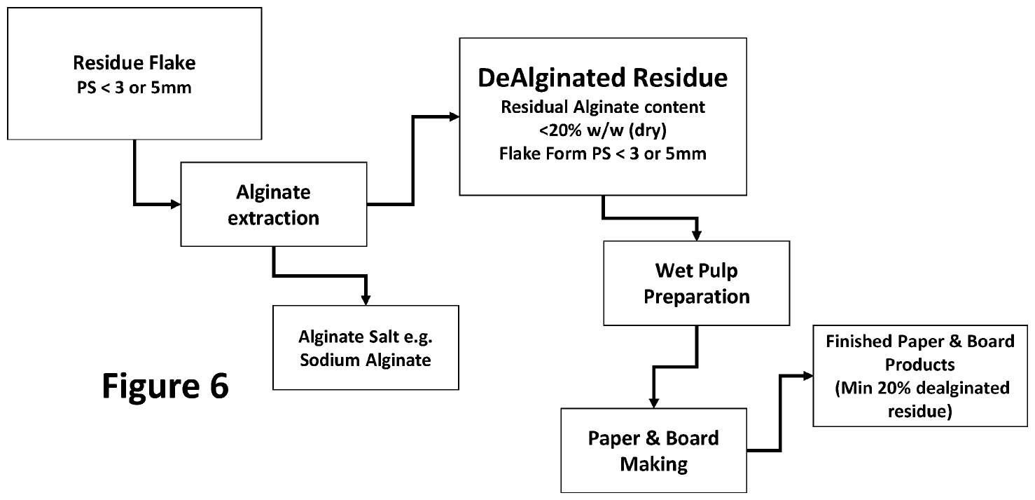

FIG. 6 illustrates example processing downstream process to form kelp residue/processed residual seaweed for inclusion in Paper and Board formulations;

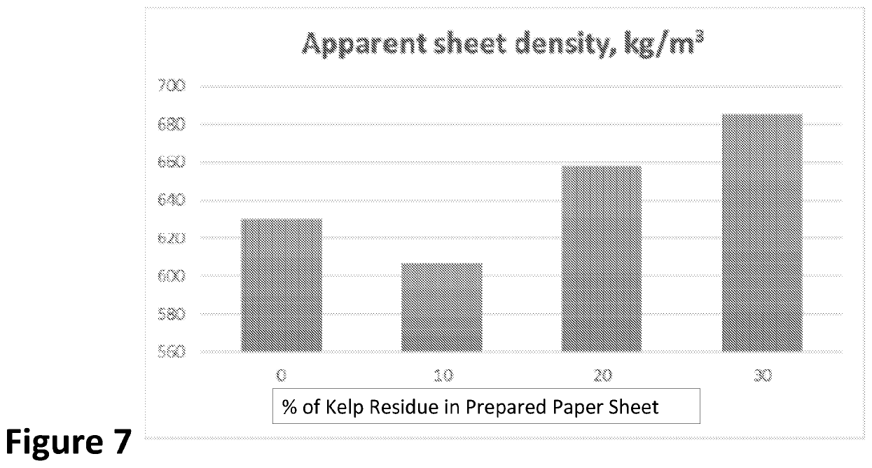

FIG. 7 illustrates paper sheet density as a function of percentage kelp residue;

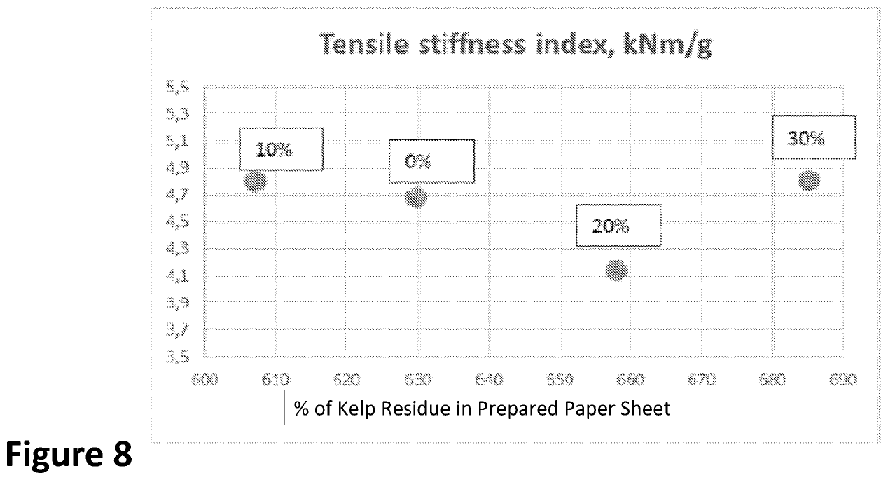

FIG. 8 illustrates tensile stiffness in the function of sheet density with the kelp residue level in paper sheets;

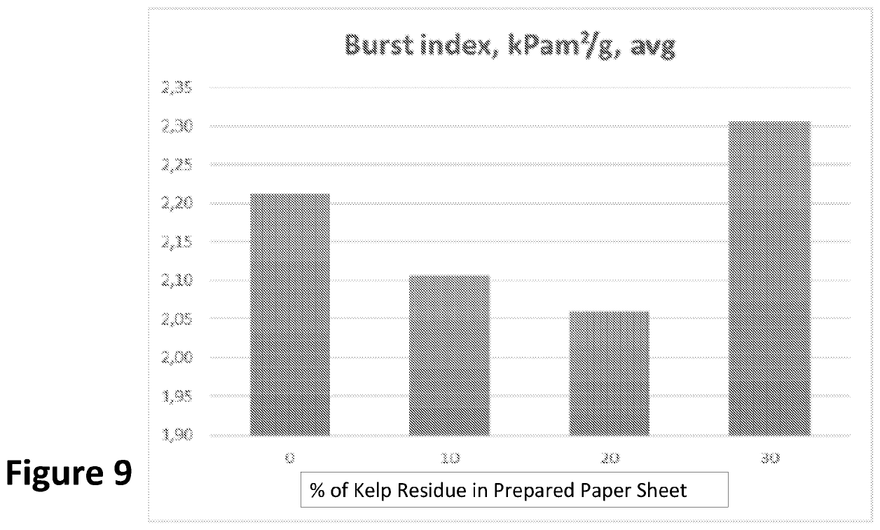

FIG. 9 illustrates an average of burst index of paper sheets as the function of kelp residue level; and

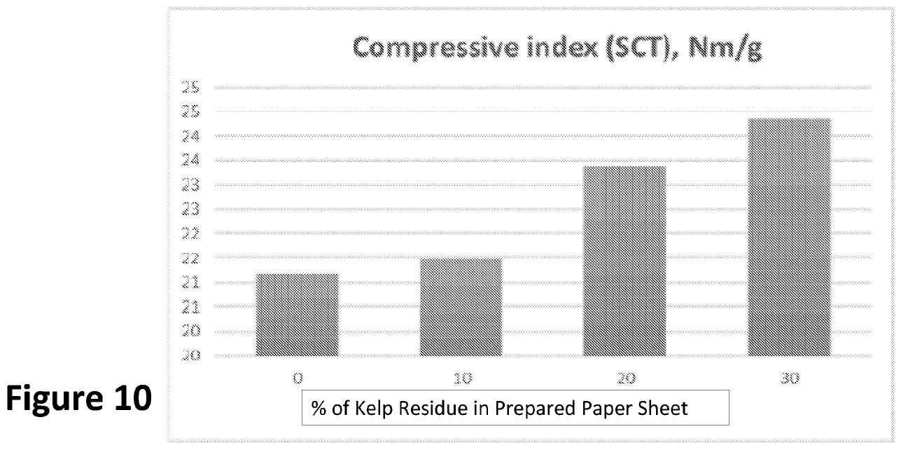

FIG. 10 illustrates compressive index as a function of kelp residue level in paper sheets.

### DETAILED DESCRIPTION OF THE INVENTION

Where seaweed extracts have been used in packaging, alginate coatings have been utilised to provide an oxygen barrier and to retard lipid oxidation in foods. Starches have also been utilised in film forming compositions for use in packaging. However, both alginates and starches when applied to base material to form substrates are known to suffer from disadvantages and can cause the substrate to lack structural integrity or have undesirable qualities for example, such that the substrate has poor moisture barrier properties, the treated substrate can be brittle, or treatment can cause disintegration of substrate when in contact with water or be subject to enzymatic hydrolysis.

Described herein are composite formulations, including low water content compositions, middle water content formulations and high water content formulations.

### Example 1—High Water Content Composite

A high water composition comprising 1-75% alginate containing fraction and 0-99% residual processed seaweed product fraction wherein the product fraction comprises substantially insoluble alginate and other insoluble components was used to form a functional film.

The composition comprises
10-60% w/w Kelp residue, wherein the residue comprises 1-80% w/w alginate;
and 1-99% insoluble fractions
0-20% w/w functional additives, selected from
   a) 10-60% w/w plasticiser;
   b) 10-60% w/w film former; and
   c) 0-20% w/w filler.

The composition was able to be provided to a substrate such as paper, board or textile.

In particular three specific compositions/composites were generated:

Example Formulations with <100% Naturally Derived components

### Composition 1: (Basic Ink/Coating Formulation)

Processed Seaweed Residue (Kelp Residue) 11.5% w/w wet (57.5% w/w dry)
Hydroxy Ethyl Cellulose (90K Mw: Supplier Merck) 1.0% w/w wet (5% w/w dry)
Poly Vinyl Alcohol (ST90002DHV: Supplier Scitech) 1.0% w/w wet (5% w/w dry)
Glycerol (Supplier Merck) 6.5% w/w wet (32.5% w/w dry)
Remainder is Water ˜80% w/w

### Composition 2: (Inclusion of Koalin Improved Stiffness Lighter Colour)

Processed Seaweed Residue (Kelp Residue) 10.45% w/w
Hydroxy Ethyl Cellulose (90K Mw: Supplier Merck) 0.91% w/w
Poly Vinyl Alcohol (ST90002DHV: Supplier Scitech) 0.91% w/w
Glycerol 5.91% w/w
Kaolin 1.81%
Remainder is Water ˜80.00% w/w

### Composition 3: (Higher PVOH More Flexible Sheet)

Kelp Residue 9.5% w/w
Polyvinyl Alcohol (ST90002DHV: Supplier Scitech) 14.2% w/w
Glycerol 6.6% w/w/
Remainder is Water 69.7% w/w

### Composition 4 (Higher PVOH More Flexible Sheet Higher Residual Acetate Content Target Improved Hydrophobicity)

Kelp Residue 9.5% w/w
Polyvinyl Alcohol (Kurray 4-88) 14.2% w/w
Glycerol 6.6% w/w/
Remainder is Water 69.7% w/w

### Composition 5: (Higher PVOH More Flexible Sheet Low Residual Acetate Content Target Improved Hydrogen Bonding Capability Stronger Sheet))

Kelp Residue 9.5% w/w
Polyvinyl Alcohol (Kurray 4-98) 14.2% w/w
Glycerol 6.6% w/w/
Remainder is Water 69.7% w/w

### Composition 6: (Higher PVOH More Flexible Sheet Higher Residual Acetate Content Target Hydrophobicity, Presence of Carboxylate Groups in PVOH Improved Crosslinking to Alginates)

Kelp Residue 9.5% w/w
Polyvinyl Alcohol (Kurray 3-86 SD) 14.2% w/w
Glycerol 6.6% w/w/
Remainder is Water 69.7% w/w

### Composition 7: (High EVA Content Gives Improved Hydrophobicity and Improved Flexibility of Dried Sheets)

Kelp Residue 9.5% w/w
EVA (Trilliium 1016) 20.7% w/w
Glycerol 3.6% w/w/
Remainder is Water 66.2% w/w

### Composition 8: (High EVA Content Gives Improved Hydrophobicity and Improved Flexibility of Dried Sheets)

Kelp Residue 9.5% w/w
EVA (Trilliium 1016) 17.0% w/w
Glycerol 3.6% w/w/
Remainder is Water 69.9% w/w

### Composition 9: (High EVA Content Gives Improved Hydrophobicity and Improved Flexibility of Dried Sheets)

Kelp Residue 9.5% w/w
EVA (Trilliium 1374) 17.0% w/w
Glycerol 3.6% w/w/
Remainder is Water 69.9% w/w

### Composition 10: (High EVA Content Gives Improved Hydrophobicity and Improved Flexibility of Dried Sheets and No Glycerol Further Improved Hydrophobicity)

Kelp Residue 11.0% w/w
EVA (Trilliium 1374) 19.0% w/w
Remainder is Water 69.9% w/w

### Composition 11: (High EVA Content Gives Improved Hydrophobicity and Improved Flexibility of Dried Sheets+AKD to Give Further Improved Hydrophobicity and Flexibility)

Kelp Residue 9.0% w/w
EVA (Trilliium 1374) 16.7 w/w
C16:C18 1:1 ratio Alkyl Ketene Dimer 0.45% w/w (Solensis Aq320F)
Glycerol 3.6% w/w
Remainder is Water 69.5% w/w

### Composition 12: High EVA Content Gives Improved Hydrophobicity and Improved Flexibility of Dried Sheets and Rosin to Give Further Improved Hydrophobicity.

Kelp Residue 9.0% w/w
EVA (Trilliium 1374) 17.0 w/w
Hercat 27JP4 0.1% w/w (Solensis Rosin)
Glycerol 3.6% w/w
Remainder is Water 69.5% w/w

### Composition 13: High EVA Content Gives Improved Hydrophobicity and Improved Flexibility of Dried Sheets+Presence of Rosin and No Glycerol Further Improved Hydrophobicity)

Kelp Residue 9.0% w/w
EVA (Trilliium 1374) 20.6 w/w
Hercat 27JP4 0.1% w/w (Solensis Rosin)
Remainder is Water 69.5% w/w

### Example 100% Naturally Derived Formulations

### Composition 14: (100% Natural Mix Less Mobile Plasticiser)

Kelp Residue 13.34% w/w
Sorbitol 6.67% w/w
Remainder is Water 80.00% w/w
   Composition 15: 100% Naturally Derived Mix with Elastic Protein as Additional Film Former
Kelp Residue 10.0% w/w
Protein Marine Collagen) 20.6% w/w (My Protein Supplier)
Remainder is Water w/w
   Composition 16: 100% Naturally Derived Mix with Elastic Protein as Additional Film Former+AKD to Improve Hydrophobicity and Flexibility
Kelp Residue 10.0% w/w
Protein Marine Collagen) 20.6% w/w (My Protein)
C16:C18 1:1 ratio Alkyl Ketene Dimer 0.45% w/w (Solensis Aq320F))
Remainder is Water 69.0% w/w
   Composition 17: 100% Naturally Derived Mix with More Hydrophobic and Elastic Protein as Additional Film Former
Kelp Residue 9.0% w/w
Protein Pea Protein Concentrate 20.6% w/w (AM Nutrition)
Remainder is Water 69.5% w/w
   Composition 18: 100% Naturally Derived Mix with More Hydrophobic and Elastic Protein as Additional Film Former+AKD to Improve Hydrophobicity and Flexibility
Kelp Residue 9.0% w/w
Protein Pea Protein Concentrate 20.6% w/w (AM Nutrition)
C16:C18 1:1 ration Alkyl Ketene Dimer 0.45% w/w (Solensis Aq320F))
Remainder is Water 69.0% w/w
   Composition 19 100% Naturally Derived Mix with More Hydrophobic and Elastic Protein as Additional Film Former and Glycerol to Improve Flexibility
Kelp Residue 10.8% w/w
Protein Pea Protein Concentrate 15.0% w/w (AM Nutrition)
Glycerol 4.3% w/w (Merck)
Remainder is Water 70.0% w/w
   Composition 20: 100% Naturally Derived Mix with Flexible Starch as Additional Film Former.
Kelp Residue 10.8% w/w
Pulluan 19.1% w/w (TIC Supplier)
Remainder is Water 70.0% w/w
   Composition 21: 100% Naturally Derived Mix with Flexible Starch as Additional Film Former and Cork to Improve Flexibility and Hydrophobicity.
Kelp Residue 11.2% w/w
Pullan 4.8% w/w (TIC Supplier)
Sub 100 μm Cork Powder 4.0%*(Korkowy Poland)
Remainder is Water 70.0% w/w
   Composition 22: 100% Naturally Derived Mix with Hydrophobic Marine Polysaccharide as Additional Film Former and Cork to Improve Flexibility and Hydrophobicity.
Kelp Residue 11.2% w/w
Kappa Carrageenan 2.8% w/w (Konrad Nutrition
Sub 100 μm Cork Powder 6.0%*(Korkowy Poland)
Remainder is Water 70.0% w/w
   Composition 23 100% Naturally Derived Mix with More Hydrophobic and Elastic Protein as Additional Film Former
Kelp Residue 10.8% w/w
Protein Wheat Gluten 19.1% w/w (Purima)
Remainder is Water 70.0% w/w
   Composition 24 100% Naturally Derived Mix with More Hydrophobic and Elastic Protein as Additional Film Former with Glycerol to Improve Flexibility
Kelp Residue 10.8% w/w
Protein Wheat Gluten 15.0% w/w (Purima)
Glycerol 4.3% w/w (Merck)
Remainder is Water 70.0% w/w
   Composition 25 100% Naturally Derived Mix with More Hydrophobic and Elastic Protein as Additional Film Former with Natural to Improve Flexibility and Hydrophobicity
Kelp Residue 10.8% w/w
Protein Wheat Gluten 13.0% w/w (Purima)
Rapeseed Oil 6.5% w/w w/w (Mazola)
Remainder is Water 70.0% w/w
   Example Base Formulations with Additional Colourants

### Composition 26: (Black Ink)

(Kelp Residue) 10.4% w/w wet
Hydroxy Ethyl Cellulose (90K Mw: Supplier Merck) 0.9% w/w wet (Poly
Vinyl Alcohol (ST90002DHV: Supplier Scitech) 0.9% w/w wet
Recycled Carbon Black 2.0%
Glycerol (Supplier Merck) 5.9% w/w wet
Remainder is Water 80% w/w

### Composition 27: (A Synthetic Blue Tinted Ink)

(Kelp Residue) 10.4% w/w wet
Hydroxy Ethyl Cellulose (90K Mw: Supplier Merck) 0.9% w/w wet (Poly
Vinyl Alcohol (ST90002DHV: Supplier Scitech) 0.9% w/w
Hydroflex Blue 2.0% (DVM Pigments and Additives)
Glycerol (Supplier Merck) 5.9% w/w
Remainder is Water 80% w/w

### Composition 28: (A Synthetic Yellow/Green Tinted Ink)

(Kelp Residue) 10.4% w/w wet
Hydroxy Ethyl Cellulose (90K Mw: Supplier Merck) 0.9% w/w wet (Poly
Vinyl Alcohol (ST90002DHV: Supplier Scitech) 0.9% w/w
Hydrotint Yellow 1838 2.0% (DVM Pigments and Additives)
Glycerol (Supplier Merck) 5.9% w/w
Remainder is Water 80% w/w

### Composition 29: (A Beige Tinted Lightened Ink)

(Kelp Residue) 10.4% w/w wet
Hydroxy Ethyl Cellulose (90K Mw: Supplier Merck) 0.9% w/w wet (Poly
Vinyl Alcohol (ST90002DHV: Supplier Scitech) 0.9% w/w
Hydroflex White HR7 2.0% (DVM Pigments and Additives)
Glycerol (Supplier Merck) 5.9% w/w
Remainder is Water 80% w/w

### Composition 30: (A Beige Lightened Base Further Naturally Blue Tinted Ink) (Kelp Residue) 9.2% w/w Wet

Hydroxy Ethyl Cellulose (90K Mw: Supplier Merck) 0.8% w/w wet (Poly
Vinyl Alcohol (ST90002DHV: Supplier Scitech) 0.8% w/w
Hydroflex White HR7 2.0% (DVM Pigments and Additives)
Spirolina Blue 2: 0% (Scotbio)
Glycerol (Supplier Merck) 5.2% w/w
Remainder is Water 80% w/w

### Composition 31 (A Naturally Blue Tinted Ink)

(Kelp Residue) 8.1% w/w wet
Hydroxy Ethyl Cellulose (90K Mw: Supplier Merck) 0.7% w/w wet (Poly
Vinyl Alcohol (ST90002DHV: Supplier Scitech) 0.7% w/w
Spirolina Blue 6: 0% (Scotbio)
Glycerol (Supplier Merck) 4.6% w/w
Remainder is Water 80% w/w

### Composition 32: (A Naturally Yellow Tinted Ink)

Kelp Residue) 10.4% w/w wet
Hydroxy Ethyl Cellulose (90K Mw: Supplier Merck) 0.9% w/w wet (Poly Vinyl Alcohol (ST90002DHV: Supplier Scitech) 0.9% w/w
Turmeric Powder 2.0% (Aldi)
Glycerol (Supplier Merck) 5.9% w/w
Remainder is Water 80% w/w

### Example 2—Medium Water Content Composite

A medium water content composition/formulation can also be provided. The moisture content at preparation and further processing is 25-50% w/w. These mixes have non water components identical in nature and relative ratios to high water mixes. However medium water mixes are prepared in and can be further processed using thermoplastic processing equipment. This means they can be used to make pellets, as well as 2D films and 3D Injection moulded parts. A suitable composition is provided below.
Kelp Residue 32.18% w/w
Sorbitol 16.09% w/w
C16:C18 1:1 ration Alkyl Ketene Dimer 0.74% w/w (Solensis Aq320F)
Nanocellulose 0.49% w/w (Exilva Borregaard)
Kaolin 0.49% w/w
Remainder is Water 50% w/w.

### Example 3—Low Water Content Composite

A low water composition comprising less than 70% alginate containing fraction and 10-99% residual processed seaweed product fraction wherein the product fraction comprises substantially insoluble alginate and other insoluble component was used to form a functional film. A composition comprising polylactic acid a plasticiser to form a thermoplastic material which can be extruded to form 2D and 3D shapes using the thermoplastic composition was formed.

A suitable composition is provided below.

Kelp Residue 10% w/w

Injection Moulding Grade PLA Based Compound 90% w/w (supplied by Floreon Ltd)
PLA 70% w/w
Low Melting point Linear Aliphatic Polymer Ester 30% w/w

It was determined that a thermoplastic composition wherein the thermoplastic is residual processed seaweed and PLA, wherein the residual processed seaweed comprises at least 8%, suitably about 10% of the composition, provides a greater rate of biodegradation that a biodegradable polymer control of PLA alone. Suitably the rate of biodegradation is increased by about 100%.

| | Final Degree of Disintegration ISO20200/ |
|---|---|
| Material Tested | Average of 3 runs |
| PLA injection Moulding | 27.7% |
| Formulation Control | |
| Example 3 Low water | 63.7% |
| content composite | |

### Example 4—Alginate Extraction

A low water composition comprising less than a 70% alginate containing fraction and 10-99% residual processed seaweed product fraction, wherein the product fraction comprises substantially insoluble alginate and other insoluble component, was used to form a functional film. The low water composition further undergoes an alginate extraction step to form alginate salt and a dealginated residue. The dealginated residue may be used in a wet pulp preparation to form a paper product.

### Example 5—Paper and Board Composites

Paper and Board composites involve using the kelp residue in paper and board making formulations. The kelp residue can act as a structural part of resulting paper/board web. Additionally or alternatively the kelp residue can provide a simple organic natural filler and/or a functional additive in the paper or board. The formulation of the composition can comprise virgin Kraft pulp or pulp from recycled fibres along with the other typical paper additives and processing aids. Based on the non volatile components the formulation can be 1-30% kelp residue. Typically the formulation can be 1% solids. The kelp residue can be added to the paper making process at the pulper stage prior to dilution. An example of a paper and board composite can be repulped corrugated board Fibre 0.8%. w/w, Kelp Residue 0.2% w/w and water 99% w/w

### Example 6—Curing of Kelp Residue Containing Materials

The alginate fraction (for example sodium alginate (NaAlg)) of products prepared using the residual processed seaweed product/kelp residue can be cured or crosslinked. This crosslinking of alginate can be carried out to render the alginate insoluble and to improve the toughness and particularly the water resistance of material that contain significant quantities of for example monovalent alginate, e.g. sodium alginate.

The crosslinking is normally achieved by ion exchanging a monovalent counter ion associated with the alginate polyanionic polymer with a divalent (or polyvalent) counter ion. Monovalent counter ions (most commonly the Sodium ion Na+) normally mean the alginate salt is water soluble. Alginate polyanionic polymer with a Divalent (most commonly the Calcium ion Ca2+) counter ion are insoluble.

The ion exchange achieves crosslinking as the polyvalent ions interact with more than one carbonyl group present on the alginate polyanionic polymer backbones both intra and more significantly intermolecularly. Such bridging is thought to exclude the solvation water from between the alginate polyanionic polymer backbones so rendering them insoluble. Examples of monovalent counter ions used with alginate can be Na+, K+, Ammonium (NH4+) Quaternary Amines NR4+ where R=Hydrogen or the typical organic moieties.

Polyvalent ions are most commonly metal ions, typical examples being Ca2+Mg2+, Fe3+, Al3+ but almost any polyvalent metal ion could used.

### Curing Process.

Materials containing the monovalent alginate form were soaked in a solution of a polyvalent (Mⁿ⁺ where n>1) metal salt. This can be done by dipping parts in bath of the polyvalent metal salt or by spraying a part with a polyvalent salt solution. The curing solution concentration can be varied with the higher concentration meaning less soaking time is needed. Concentration is usually quoted % polyvalent metal ion, as the metal salt negative counter ion can be varied. Concentration of the metal salt can vary from 0.1% w/w metal ion to 20% or higher if solubility of the salt allows.

It has been shown it is also possible, where solubility characteristics allow, to dissolve the curing salt in mixtures of water and water soluble plasticiser e.g. glycerol. This helps to overcome post cure embrittlement issues associated with leaching of plasticisers during the soaking and curing processes. It has further been shown that curing can be achieved when coating or screen printing by coating the formulations described herein onto paper or card substrate soaked in the curing solution. Alternatively, the kelp residue formulations describe herein can be coated onto precoated layers of a non alginate film forming polymer doped with polyvalent metal ions or coating layers of non alginate film forming polymer doped with polyvalent metal ions between or onto top of layer mix mixes.

Curing parts were left in contact with the uncured parts for controlled amounts of time, the aim being to ensure the curing ions fully diffuse into the uncured material. After soaking, the parts were then dried. The diffusion and drying process can be aided using pressure combined with contact to absorbent materials. In the case of material sheets this is done by placing the soaked sheets on layers of absorbent material, (e.g. Kitchen roll or felt) stacking these on top each other, covering the stack with a final layer of absorbent material and placing weights Pressure (proving pressure of ≥150 kg/m2) on the stack for a fixed time period minimum 4 hrs. After this treatment the sheets are removed and further dried to leave ≈10% w/w water in the final sheet.

In an example curing process, a sheet of cast film weight 5.724 (12.4% w/w water of (Dry mass=5.014 g→water=14.2 of dry mass) was immersed in a 10% w/w solution of Calcium Chloride (3.6% Ca2+) for 5 mins Mass after immersion 7.2033 mass gain=1.479 g (Mass Ca2+ transferred)=(1.479*0.036)=0.053 g. The sheet was placed on top of a sheet of filter paper covered with a second sheet of filter paper then pressed for 180 mins with pressure of 167 kg/m2. Mass sheet after pressing=6.766 g. The sheet was then left to dry at ambient for 3 days Final Sheet mass=5.667 g. (% H20=13.0% of dry mass). The sheet was then left to equilibrate at ambient for a further 17 days Final recorded mass=5.571 g (% H20=11.1% of dry mass).

### Example 7

The use of the kelp residue, as described herein, as a kelp residue powder within a biodegradable old corrugated containers (OCC) sheet was considered. The processed seaweed residue product (kelp residue) was mixed with the OCC pulp to produce testliner board. After the blend sheet making, the pulp and paper properties were tested. Shopper Riegler (SR) values that represent dewatering of pulp rose rapidly with increasing amount kelp residue. The kelp residue was not considered to increase the strength like fibers but was considered to act as an organic filler to fill the voids between fibers at the paper structure.

Blend sheet preparations were prepared as per Table 1.

TABLE 1

| Sample | KP1 | KP2 | KP3 | KP4 |
|---|---|---|---|---|
| OCC, % | 100 | 80 | 70 | 90 |
| Kelp residue, | 0 | 20 | 30 | 10 |
| % | | | | |

After sheet making the preparations were dried against a gloss surface with preventing sheet shrinkage.

As more kelp residue was added the sheets appeared to visually darken in colour. Characteristics of the prepared sheets were assessed as shown in FIGS. 7 to 10.

### Example 8—Medium Moisture Compositions

Extrusion processing was undertaken using 60 g kelp residue flakes with a particle size up to 4 mm, sorbitol (kelp residue flakes 0.7: sorbitol 0.3 (dry content) @40-50% moisture at processing temperature of 100° C.). The compositions could be pressed into a plate (e.g. 100 mm×100 mm×2 mm).

Several additives were also tested:
Sorbitol: Function: Natural Plasticiser, (Hydrophilic)
   Glycerol could also be used
Alkylketene Dimer (AKD): Function: Reactive Hydrophobing (Sizing) agent and possible hydrophobic additional plasticiser
   Added as 20% Wax dispersion in water
   Highest additional level 1.5% w/w dry on non volatile content resulting sheet very flexible no evidence of improved water resistance
Nanocellulose. Function: Strengthening and flexibilising agent
   Kaolin Function: White Colour modifying (Lightening) pigment and potential odour reduction.

Using Sorbitol with Kelp residue flakes of up to 4 mm sorbitol (kelp residue flakes 0.7: sorbitol 0.3 (dry content) @40-50% moisture at processing temperature of 100° C.) continuous films could be provided at relatively high thickness (0.3 to 0.8 mm).

Using a moisture content of about 25%-30% with reduced sorbitol content ((kelp residue flakes 0.8: sorbitol 0.2 (dry content)) then injection moulding of the composite was possible. Pellets could be formed using kelp residue powder with an average sizing of 60 μm and maximum sizing of 160 μm.

### Example 9—Low Moisture Composition-Injection Molding

Using a resin formulation mix with kelp residue (10%), PLA (70%) and additive (20%), injection molding was used to form boxes of material. The boxes were found to be of a consistent colour and finish and an emboss could be achieved on the box surface.

### Example 10—Low Moisture Composition—Extrusion Product

A kelp residue (30%), PLA (70%) mix was prepared and fed into an extruder. The extrudate was found to be brittle.

A second mix incorporating a linear aliphatic and compostable polyester was prepared. The second mix could be compounded at lower temperatures that the PLA mix and was found to be soft and rubbery with excellent melt strength. Even at low loadings (10%) the extrudate was found to be very hydrophilic and appeared to have improved compostability.

A third mix incorporating a 70/30% mixture of flow enhancing additive (wax with excellent flow and adhesion to natural fillers) was prepared and collected. The blend processed well and maintained excellent flexibility and melt strength.

### Example 11—Specific Thin Film Compositions Generated

Compositions as described in Table 2 were formed into thin clear films.

TABLE 2

| | | | | % Kelp | | Drying | |
|---|---|---|---|---|---|---|---|
| | % | % Non | % | in Dry | | Temp | Film |
| | NaAlg | Volatiles | H20 | Form | Processing | ° C. | μm |
| 1 | 2.50% | 4.5% | 95.5% | 55.6% | Wet Cast | 40 | ≈500 |
| 2 | 5.00% | 9.0% | 91.0% | 55.6% | Wet Cast | 40 | ≈500 |
| 3 | 7.50% | 13.5% | 86.5% | 55.6% | Wet Cast | 60 | ≈500 |
| 4 | 11.10% | 20.0% | 80.0% | 55.6% | Wet Cast | 70 | ≈500 |

Compositions as described in Table 3 were also formed into clear films using a PVOH film former.

TABLE 3

| | | | | | | % | | | |
|---|---|---|---|---|---|---|---|---|---|
| | | | % | | | Kelp | | | |
| | | | Low | | | in | | Drying | |
| | % | % Non | Mw | % | | Dry | | Temp | Film |
| | NaAlg | Volatiles | PVOH | Glycerol | % H20 | Form | Processing | ° C. | μm |
| 1 | 3.00% | 9.0% | 3.00% | 3.00% | 91.0% | 33.3% | Wet Cast | 40 | ≈500 |
| 2 | 5.00% | 12.0% | 2.50% | 4.50% | 88.0% | 41.7% | Wet Cast | 60 | ≈500 |
| 3 | 6.25% | 15.0% | 3.13% | 5.63% | 85.0% | 41.7% | Wet Cast | 70 | ≈500 |
| 4 | 8.35% | 20.0% | 4.18% | 7.52% | 80.0% | 41.7% | Wet Cast | 70 | ≈500 |

Compositions in Table 4 were formed using HEC film fomer with processing being by wet cast.

TABLE 4

| | | % | % | | | | % | | |
|---|---|---|---|---|---|---|---|---|---|
| | | HEC | HEC | | | | Kelp | Drying | |
| | % | 90K | 1.3M | % | % Non | | in Dry | Temp | Film |
| | NaAlg | Mw | Mw | Glycerol | Volatiles | % H20 | Form | ° C. | μm |
| 1 | 6.25% | 3.13% | 0.00% | 5.63% | 15.0% | 85.0% | 41.7% | 70 | ≈500 |
| 2 | 6.25% | 2.50% | 0.63% | 5.63% | 15.0% | 85.0% | 41.7% | 70 | ≈500 |
| 3 | 7.15% | 1.79% | 0.00% | 6.08% | 15.0% | 85.0% | 47.6% | 70 | ≈501 |
| 4 | 9.50% | 2.38% | 0.00% | 8.08% | 20.0% | 80.1% | 47.6% | 71 | ≈502 |

Compositions in Table 5 were formed using PVOH and HEC using wet cast processing.

TABLE 5

| | | % | % | | | | % | | |
|---|---|---|---|---|---|---|---|---|---|
| | | HEC | Low | | | | Kelp | Drying | |
| | % | 90K | Mw | % | % Non | | in Dry | Temp | Film |
| | NaAlg | Mw | PVOH | Glycerol | Volatiles | % H20 | Form | ° C. | μm |
| 1 | 9.50% | 1.19% | 1.19% | 8.08% | 20.0% | 80.1% | 47.6% | 71 | ≈502 |
| 2 | 7.15% | 0.89% | 0.89% | 6.08% | 15.0% | 85.0% | 47.6% | 70 | ≈501 |
| 3 | 7.15% | 0.89% | 0.89% | 6.08% | 15.0% | 85.0% | 47.6% | 70 | ≈501 |

Further compositions were generated as described in FIG. 11.

### Example 12 Preparation of Cast Sheets

Various functional sheets were cast from all compositions listed.

This was carried out by applying wet layers of the formulations between 0.1 mm and 30 mm thick onto selected substrate carries. This produced dry layers between 20 and 6000 μm thick.

### Example 12A Stand Alone Sheets of Dried Formulation

For all formulations listed in Example 1 Wet coating was applied to unprimed 125 μn PolyEyhylene Terephthalate (PET) Sheet

These coated sheets were dried at ambient or in a flat air flow heater at between 3° and 70° C. before being peeled from the PET carrier sheet for further evaluation.

Peeling of the sheet left no surface residue on the PET sheets.

### Example 12B Sheets where Formulations Aimed to be Bonded to Carrier Substrate

For selected formulations from Example 1:

Wet coating being applied to range of substrate carriers ranging from Natural fabrics Muslin, woven cotton, Felts, Wools, Raw and Processed Silks, synthetic cellulosic fabric lysocells as well as paper and board. Before being dried as described above.

The first assessment was how well material bonded to the fabric. In all cases tested formulations bonded sufficiently well to the chosen substrate that it could not be removed without application of significant force. Retained sheets were stored for further analysis.

### Example 12C Colour Assessment

In other selected cases deliberately further coloured formulations from those listed in Example 1 were screen printed or painted onto selected carrier substrates including paper, board, cotton and other natural fabrics to allow visual assessment of printed colours to be carried out as well as investigate colour fastness and resistance to wash out etc.

Selected coated sheets, either stand alone or where formulation, were bonded to substrates, were cured using suitable polyvalent metal ions and performance assessed against uncured versions. In general curing improved hydrophobicity.

Although the invention has been particularly shown and described with reference to particular examples, it will be understood by those skilled in the art that various changes in the form and details may be made therein without departing from the scope of the present invention.

1. A residual seaweed product comprising:
a fraction of materials which remain after extraction of soluble compounds from whole seaweed,
wherein the fraction of materials which remain in the residual seaweed product are cellulose, proteins and soluble or insoluble alginates, and
wherein the residual seaweed product further comprises an alginate fraction comprising 1-80% w/w alginate.

2. A formulation coating or ink composite, comprising non volatile components wherein the non volatile components of the said composite comprises:
10-60% w/w residual seaweed product comprising a fraction of materials which remain after extraction of soluble compounds from whole seaweed wherein the fraction of materials which remain in the residual product are cellulose, proteins and soluble or insoluble alginates, wherein the residual seaweed product further comprises an alginate fraction comprising:
1-80% w/w alginate;
combined with functional additives, selected from
(a) 10-60% w/w plasticiser;
(b) 10-80% w/w film forming polymers;
(c) 0-30% w/w filler;
(d) 0-30% w/w other functional materials.

3. The formulation coating of claim 2 applied to a substrate, wherein the formulation following drying, forms a decorative coating or functional barrier coating on the substate wherein the substrate comprises paper, card, polymer films, and/or textile.

4. A pseudothermoplastic composition where the non volatile components comprise:
10-90% w/w residual seaweed product comprising cellulose, proteins and soluble or insoluble alginates, wherein the residual seaweed product further comprises 50-80% w/w alginate; and
combined with functional additives, selected from:
(a) 10-60% w/w plasticiser;
(b) 10-80% w/w film forming polymer;
(c) 0-30% w/w filler;
(d) 0-30% w/w other functional materials, wherein the non volatile fraction of the coating composite comprises 50-70% w/w with the balance volatile fraction 50%-30% w/w being water.

5. The formulation coating or ink composite of claim 2, wherein the film forming polymers comprise proteins.

6. The formulation coating or ink composite of claim 2, wherein the film functional materials comprise pigments and dyes.

7. The formulation coating or ink composite of claim 2, comprising 0-20% w/w filler.

8. The formulation coating or ink composite of claim 2, comprising 0-20% w/w other functional materials.

9. The formulation coating or ink composite of claim 8, wherein the functional materials are selected from hydrophobising agents, crosslinkers, or colour pigments.

10. The pseudothermoplastic composition of claim 4, wherein the plasticiser is selected from one or more of glycerol, sorbitol or hydrophobic waxes.

11. The pseudothermoplastic composition of claim 10, wherein the hydrophobic waxes comprises reactive waxes selected from the group comprising AKD and fatty acids.

12. The pseudothermoplastic composition of claim 4, wherein the alginate comprises one or more of sodium alginate, calcium alginate, potassium alginate, other ionic salt of alginate or alginic acid.

13. A thermoplastic composition comprising:
(i) 1-90% w/w residual seaweed product comprising cellulose, proteins and soluble or insoluble alginates, wherein the residual seaweed product further comprises 50-80% w/w alginate;
(ii) 10-99% w/w polymer; and
(iii) 0-50% w/w functional additives, and further comprising 0-10% w/w water.

14. A paper or cardboard composite comprising:
(i) 1-60% w/w residual seaweed product comprising cellulose, proteins and soluble or insoluble alginates, wherein the residual seaweed product further comprises 0-80% w/w alginate;
(ii) 40-99% w/w lignocellulosic fibrous material; and
(iii) 0-30% paper and board product typical functional additives.

15. The paper or cardboard composite of claim 14, wherein the paper and board product comprises functional additives optionally wherein the functional additive is at least one of sizing agent, filler, and wet strength additive.

16. A process for preparing functional materials from a formulation of claim 1, comprising:
applying the formulation to paper, textile material, cellulose materials or board,
wherein the application process comprises at least one of a commercial printing method slot die, blade coating, dip coating, or spray coating.

17. A process for preparing functional materials, wherein the printing method comprises screen printing, litho printing flexographic printing, a commercial coating or wet casting method.

18. A process for preparing 2D and 3D products using a pseudothermoplastic composition or thermoplastic composition of claim 4, comprising thermoplastic processing equipment extrusion, injection molding, compression moulding, blow moulding forming, or film casting.

19. A pseudothermoplastic composition or thermoplastic composition of claim 4, wherein the composition is provided as a pellet.

20. The thermoplastic composition of claim 13, wherein the plasticiser is selected from one or more of dodecanol, tributyrin, lauric acid, trilaurin, soyabean oil, epoxidized soyabean oil or triethyl citrate.

21. The thermoplastic composition of claim 13, wherein the alginate comprises one or more of sodium alginate, calcium alginate, potassium alginate, other ionic salt of alginate or alginic acid.

22. A pseudothermoplastic composition of claim 4, wherein the composition has a leather like appearance after processing.

23. The thermoplastic composition of claim 13, wherein the thermoplastic composition comprises residual seaweed product and a biodegradable plastic, optionally Polylactic Acid PLA, and wherein the presence of residual seaweed product provides for an increased degradation rate when compared to a control composition comprising biodegradable plastic, optionally PLA without the residual seaweed product.

24. The thermoplastic composition of claim 23, wherein the residual seaweed product is at least 8% by weight of the composition.

25. The thermoplastic composition of claim 23, wherein the residual seaweed product is at least 10% by weight of the composition.

26. A method of using a residual seaweed product as claimed in claim 1 as a composting accelerator.
